(19) United States
(12) Patent Application Publication
(10) Pub. No.: US 2014/0095341 A1
(43) Pub. Date: Apr. 3, 2014

(54) SYSTEM AND METHODS FOR GENERATING A CUSTOM MEDIA BUNDLE

(71) Applicants: Thomas Steven Woods, Arlington Heights, IL (US); Kenneth Murphy, Fort Washington, PA (US)

(72) Inventors: Thomas Steven Woods, Arlington Heights, IL (US); Kenneth Murphy, Fort Washington, PA (US)

(73) Assignee: UNITED VIDEO PROPERTIES, INC., Santa Clara, CA (US)

(21) Appl. No.: 13/631,800

(22) Filed: Sep. 28, 2012

(51) Int. Cl. G06Q 30/06

(52) U.S. Cl. 705/26.5

(57) ABSTRACT

Systems and methods for generating a custom media bundle are provided. In some embodiments, a quantity of media to be included in a custom media bundle is determined based on a user profile. A media content collection is selected, and from the media content collection a set of media assets containing a number of media assets corresponding the determined quantity is selected. A custom media bundle is generated that includes the selected set of media assets. In response to a user selection, one or more financial transactions are performed to grant the user access to the set of media assets of the custom media bundle.

### BACKGROUND

Content providers oftentimes offer media content collections for sale. This can be, for example, the episodes of a television series, a series of movies, or the broadcasts of sporting events that make up a tournament. When advertising such media content collections, content providers may bundle multiple media assets of a media content collection into a single media bundle such as, for example, a DVD set containing all episodes of a season of a television series. Such media bundles may result in the sale of more media assets than if media assets were advertised and sold individually.

Sometimes the media assets included in a media bundle may be of no interest to the user (e.g., because the user has already seen some of the media assets), and thus the user may avoid buying the entire media bundle. Traditional systems fail to take into account a given user's interests when offering such a media bundle.

### SUMMARY

In view of the foregoing, systems and methods for generating a custom media bundle are provided.

In some embodiments, a quantity of media to be included in a custom media bundle is determined based on a user profile. A media content collection is selected, and from the media content collection a set of media assets containing a number of media assets corresponding to the determined quantity is selected. A custom media bundle is generated that includes the selected set of media assets. In response to a user selection, one or more financial transactions are performed to grant the user access to the set of media assets of the custom media bundle.

In some embodiments, the media content collection is a media series, while the media assets are the episodes of this media series.

In some embodiments, determining the quantity of media assets to include in the custom media bundle is also based on an environmental factor. This environmental factor may be the context in which the custom media bundle is generated.

In some embodiments, the user profile used to determine the quantity of media assets contains information regarding a user's previous interactions with the media content collection, and the quantity of media assets is increased based on this information.

In some embodiments, the user profile used to determine the quantity of media assets contains a user's budget for purchasing media, and determining the quantity of media involves comparing the cost of one or more media assets to the user's budget. The user's budget may be increased periodically, and determining the quantity of media may involve calculating an available budget based on the time remaining until the budget is increased again and the user's budget and comparing the cost of one or more media assets to this calculated available budget.

In some embodiments, user activity is monitored and used to determine a user's viewing pattern. The quantity of media assets to include in the custom media bundle is then based on the user's viewing pattern. User activity may also be monitored to determine a number of viewing patterns for different time periods, and determining the quantity of media assets to include in the custom media bundle may then be based on the viewing pattern for the current time period.

In some embodiments, demographic characteristics of a user are stored, and matched against sample demographic characteristics of sample viewing patterns to determine an actual viewing pattern. The quantity of media assets to include in the custom media bundle is then based on this actual viewing pattern.

In one embodiment, user activities are monitored, and it is determined that, when the user watches a television series, he or she usually watches five episodes in a continuous manner. This information is then stored in a user profile. When a custom media bundle is being generated, a particular television series is selected. Furthermore, it is determined, based on the information stored in the user profile, that the custom media bundle is to include five episodes. Five episodes of the particular television series are selected, and a custom media bundle containing the selected five episodes is generated. In response to a user selection, a financial transaction is performed that allows the user to download the selected five episodes contained in the custom media bundle.

### BRIEF DESCRIPTION OF THE DRAWINGS

The above and other features of the present application, its nature and various advantages will become more apparent upon consideration of the following detailed description, taken in conjunction with the accompanying drawings, in which like reference characters

FIGS. 1 and 2 show illustrative display screens that may be used to provide media guidance application listings in accordance with some embodiments of the invention;

FIG. 3 shows an illustrative user equipment device in accordance with some embodiments of the invention;

FIG. 4 is a diagram of an illustrative cross-platform interactive media system in accordance with some embodiments of the invention;

FIG. 5 shows an illustrative user interface for displaying an advertisement for the custom media bundle within a website in accordance with some embodiments of the invention;

FIG. 6 shows an illustrative user interface for displaying a pop-up window for the custom media bundle within a media guidance application in accordance with some embodiments of the invention;

FIG. 7 shows an illustrative user interface for displaying a custom media calendar in accordance with some embodiments of the invention;

FIG. 8 is a flowchart of a process for generating a custom media bundle in accordance with some embodiments of the invention;

FIG. 9 shows an illustrative data structure for storing a user profile in accordance with some embodiments of the invention;

FIG. 10 is a flowchart of a process for determining a quantity of media assets to include in the custom media bundle based on the user profile in accordance with some embodiments of the invention;

FIG. 11A and FIG. 11B are flowcharts of processes for determining a quantity of media assets to include in the custom media bundle based on the user profile and an environmental factor in accordance with some embodiments of the invention;

FIG. 12 is a flowchart of a process for populating a data structure for the custom media bundle in accordance with some embodiments of the invention; and

FIG. 13A and FIG. 13B are flowcharts of processes for performing one or more financial transactions to grant the user access to the media assets of the custom media bundle in accordance with some embodiments of the invention.

### DETAILED DESCRIPTION OF EMBODIMENTS

The amount of content available to users, including media assets and media bundles available for purchase, in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

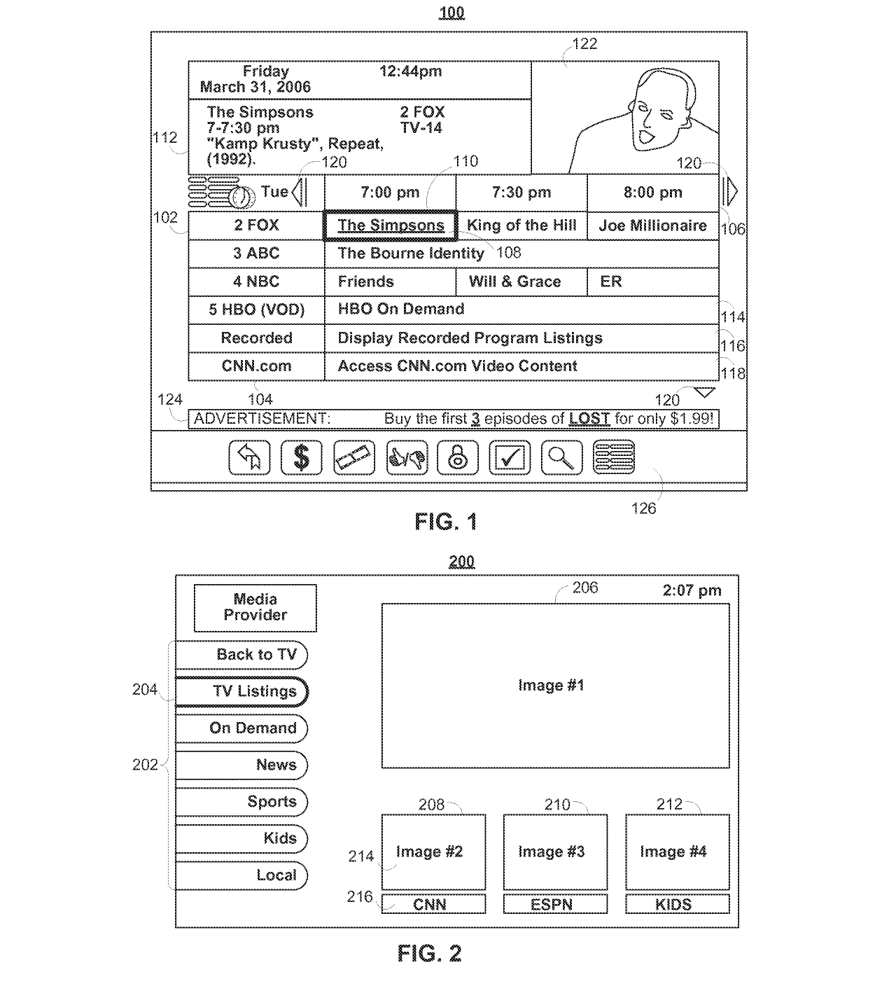

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102.

Advertisement 124, as illustrated in FIG. 1, may also advertise a media bundle consisting of one or more media assets of a media content collection.

A media content collection is a collection of media assets that could be provided independently of one another. A media content collection may be the episodes of a television series that aired during a single season, or all episodes of the television series that were produced. A media content collection may also be a collection of movies, such as all movies directed by a specific director. Media content collections are also not limited to visual media. A media content collection can be a musical album or a compilation of all songs produced by an artist. Furthermore, media assets and media content collections are not limited to media content that is stored and that can be played back repeatedly. A live broadcast of a future sporting event may be a media asset, while the collection of live broadcasts of all events of a tournament may be a media content collection.

The media assets of a media content collection all share a common characteristic that causes them to be part of a media content collection. This may include being episodes of the same television series, starring the same actor/actress, having the same producer and/or director, being from the same genre, or being classified as belonging together in some other manner. The media assets may be innately part of the media content collections due to one of these shared characteristics (e.g., the episodes of the first season of a television series are part of the episodes first season) or may be part of the media content collection at the discretion of an entity or individual (e.g., a television critic generates a “best of” media content collection consisting of his or her favorite episodes of a television series).

A media bundle consists of one, multiple, or all of the media assets of a media content collection that are advertised or otherwise provided to the user together. For example, a media bundle may be a playlist of an artist's songs, a DVD containing the editor's pick of episodes of a television series, the set of soccer games in which a particular team is playing, or the favorite books of an author.

If a user is charged for accessing a media bundle, access to a media bundle is granted, or at least appears to the user as being granted, through a single financial transaction. This may involve a content provider selling the entire media bundle as a single item. This, in turn, may be reflected by the fact that the content provider is advertising the entire media bundle together, not allowing users to purchase media assets of the media bundle individually, including a single item for the entire media bundle on receipts and invoices, performing a single transaction with a financial institution associated with the user to transfer funds for the cost of the media bundle and/or allowing a user to purchase the entire media bundle by selecting a single option.

Alternatively, receiving access to a media bundle may only appear to the user as involving a single financial transaction, but in reality involve multiple financial transactions. For example, a content provider may advertise a media bundle as a single item and/or may allow the user to purchase the entire media bundle by selecting a single option, but each media asset of the media bundle may still appear as a separate item on receipts and invoices and/or receiving access to the media bundle may involve multiple transfers of funds from a financial institution associated with the user to the content provider. Furthermore, the multiple financial transactions may also be with multiple different content providers of the individual media assets. For example, a first media asset is purchased from a first content provider using a first financial transaction, while a second media asset is purchased from a second content provider using a second financial transaction.

Once purchased, the media bundle can be made available by the content provider using a number of different approaches. The content provider may ship a physical merchandise, such as a DVD, containing the media bundle to an address associated with the user, provide a password for accessing a website that streams the media bundle over the Internet, provide access to the media bundle for on-demand viewing via a set-top box, or transmit the media bundle for downloading to a personal computer. The different methods of receiving access to media content (e.g., downloading, streaming, physical merchandise) are referred to as types of access.

The media bundle may be available directly from a content provider associated with the advertisement. For example, a content provider may dictate or otherwise control what media assets are to be advertised as part of a media bundle in advertisement 124. Such a process may still involve having the media guidance application select and/or edit the contents of the media bundle, but the content provider is involved in the process, and purchasing the media bundle involves one or more financial transactions with the content provider.

Alternatively, the media guidance application may repackage media assets available for purchase from one or more content providers to generate its own media bundle. This may or may not occur with the content providers' knowledge and/or approval. Purchasing such a media bundle may involve performing one or more financial transactions between the user and the one or more content providers, or may involve performing one or more financial transactions between the user and a provider of the media guidance application and/or advertisement 124, with the provider of the media guidance application and/or advertisement 124 then separately interacting with the one or more content providers.

The media guidance application may consist of instructions stored in storage 308 or received from media guidance data source 418 that, when executed by control circuitry 304, cause user device 300 to perform some or all the steps involved in the systems and methods described herein. Alternatively or in combination, the media guidance application may consist of instructions stored in a memory of media guidance data source 418 that, when executed by control circuitry of media guidance data source 418, cause media guidance data source 418 to perform some or all the steps involved in the systems and methods described herein. Actions discussed herein as being performed by the media guidance application are understood to involve loading instructions of the media guidance application to registers of control circuitry 304 and/or other control circuitry and the control circuitry executing these instructions to cause user equipment device 300, media guidance data source 418 and/or media content source 416 to perform the action described therein.

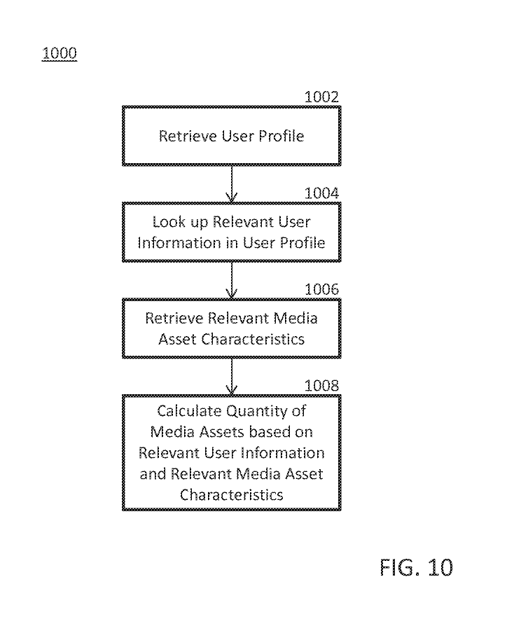

Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases. Information used to target the advertisement, such as user profile information of a user profile, will be described in further detail below in relation to customizing the media guidance application and FIG. 9.

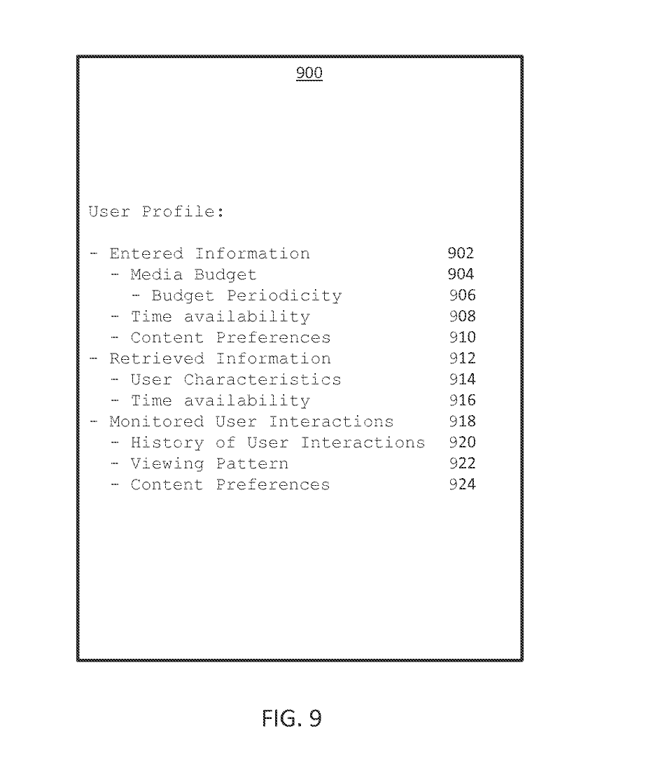

If the advertisement is for a media bundle, the advertised media bundle may be a custom media bundle that has been generated by the media guidance application based on a user profile. The number of media assets included in the custom media bundle may be determined based on the user profile. Further details of how a custom media bundle is generated and how a user may interact with it will be described further below in connection with FIGS. 8-13B.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, options to purchase media assets or media content collections, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

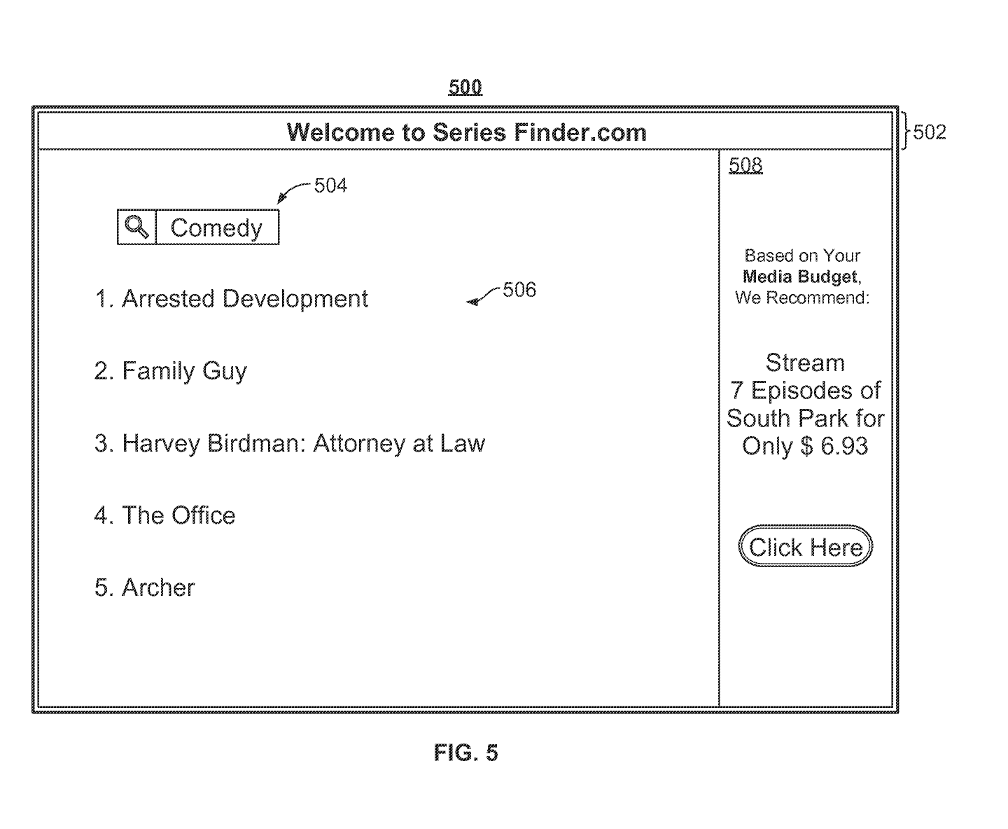

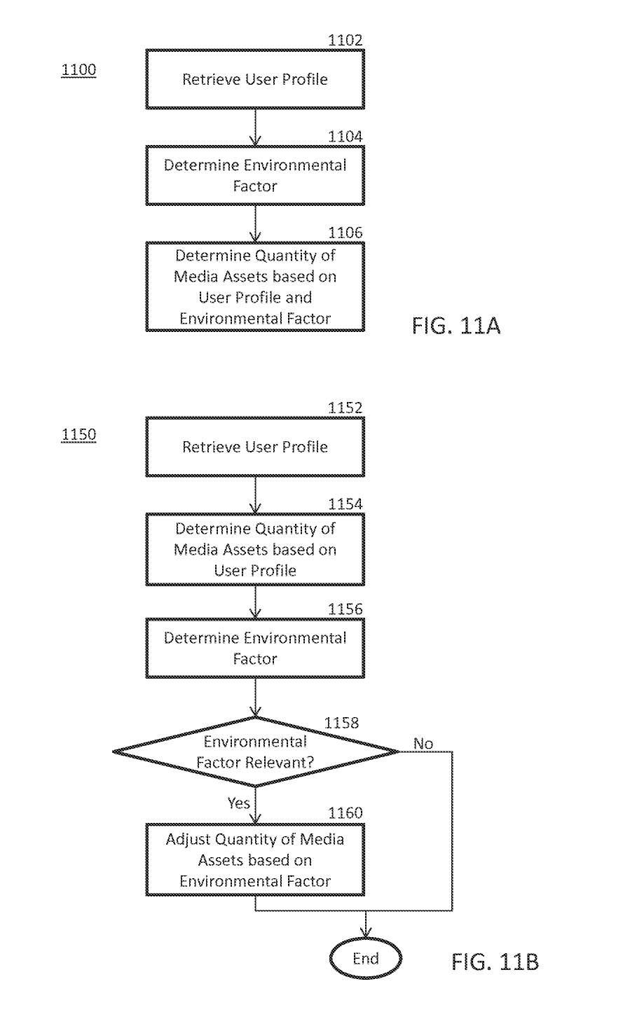

The media guidance application may allow a user to provide user profile information or may automatically compile user profile information. The media guidance application may, for example, monitor the content the user accesses and/or other interactions the user may have with the guidance application. The content of the user profile and how the user profile information is compiled will be described in greater detail below in connection with FIG. 10. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

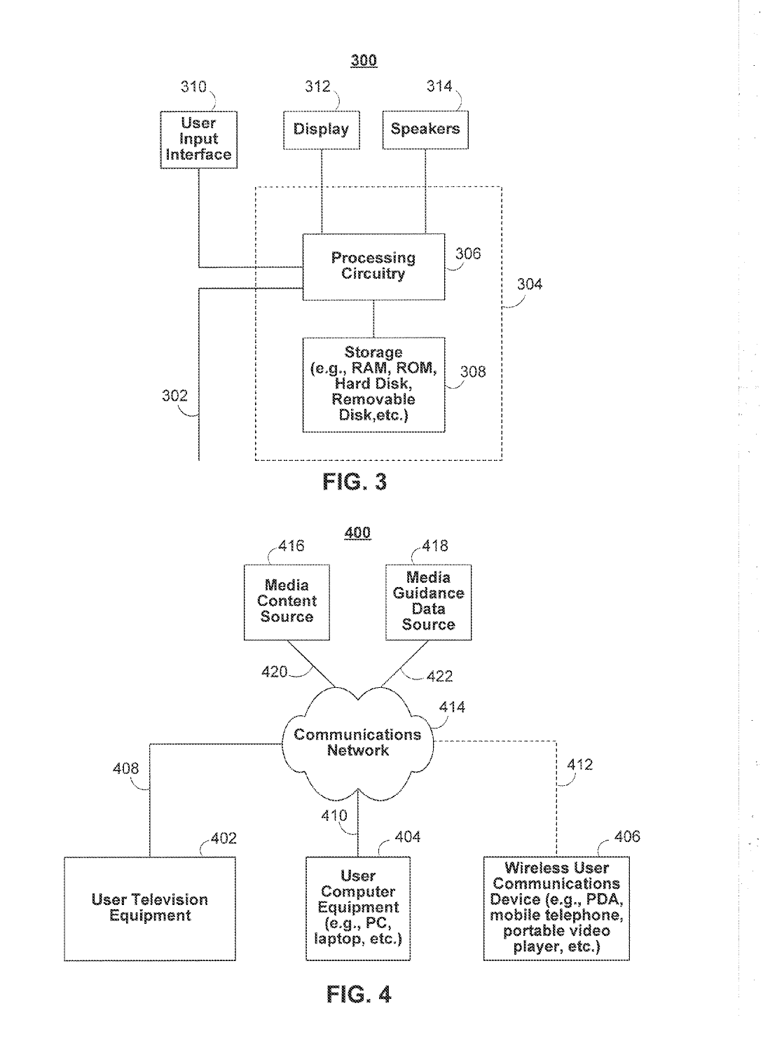

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

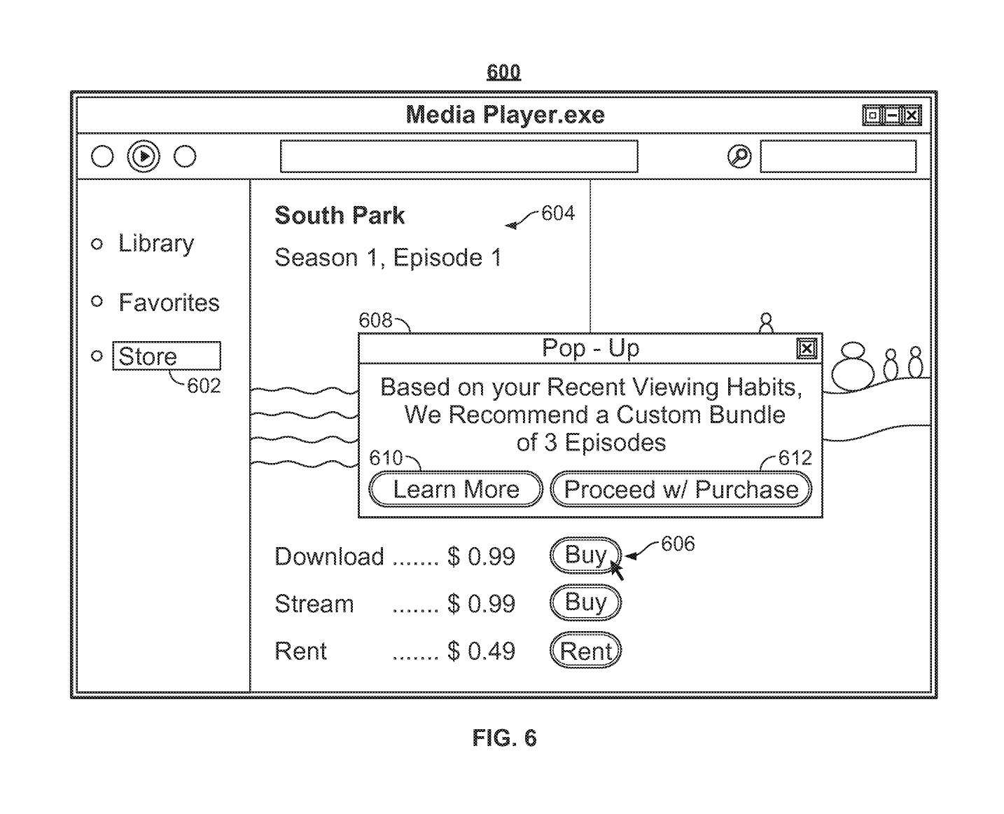

FIG. 5 demonstrates exemplary user interface 500 that has been generated by the media guidance application. User interface 500 may be a website 502 generated by media guidance data source 418 that receives a search term as input in text box 504, and performs a search for media content based on the entered search term. User interface 500 further includes a list of search results 506 and advertisement 508.

The media guidance application may contain instructions for generating user interface 500. These instructions may specify regions to be populated with information, such as search results 506, and/or other objects to be included in user interface 500, such as text box 504 or advertisement 508. These instructions, when executed, call functions of hardware drivers of user equipment device 300 with parameters defining desired regions and/or other objects, thereby causing display 312 to output these regions and/or other objects. The media guidance application may further utilize hardware drivers associated with user input interface 310 to receive user input. Information returned in response to the media guidance application periodically calling a function of one of these hardware drivers may, for example, include information indicating that the user has pressed a mouse button and the current coordinates of the mouse pointer. Alternatively, receiving a user selection may trigger an interrupt that wakes up a dormant thread involved in monitoring user interactions with the media guidance application. Based on the received user information, the media guidance application may calculate whether a user selection of a user selectable option has been received, and the media guidance application may generate a new user interface based on this received user input.

Alternatively, user equipment device 300 may generate user interface 500 based on HTML or XML code received from media guidance data source 418. The HTML or XML code may, in turn, be fully or partially dynamically generated by the media guidance application and/or may be based on predefined templates. The HTML or XML code may further specify images or other objects to be included within user interface 500. Furthermore, user selectable options in user interface 500 may include links to further websites or other information. When a user selection of one of these options is received, user equipment device 300 may request HTML or XML code corresponding to the linked-to website from media guidance data source 418.

A combination of these two approaches is also possible. For example, the majority of user interface 500 may be generated based on HTML or XML code received from media guidance data source 418, while text box 504, search results 506 and/or advertisement 508 may be generated by an embedded version of the media guidance application that is executed by user equipment device 300. For example, the embedded version of the media guidance application may be a FLASH application, a JAVASCRIPT application or an AJAX application.

User interface 500 may be displayed on display 312 of user equipment device 300 in response to user input received through user input interface 310. User interface 500 may, for example, be presented as a feature of the media guidance application for searching for on-demand media or as part of an on-line store implemented on a website.

Advertisement 508 may be an advertisement for a custom media bundle available from media content source 416. The custom media bundle may be generated by the media guidance application running on control circuitry 304 and/or media guidance data source 418. The custom media bundle may also be generated by an application running on media content source 416 and transmitted to either user equipment device 300 or media guidance data source 416 for inclusion in user interface 500. Similarly, advertisement 508 itself may be generated by the media guidance application running on control circuitry 304 and/or media guidance data source 418, or may be generated by media content source 416 and transmitted either directly to user equipment device 300 or first to media guidance data source 418.

Generating the custom media bundle may involve determining from which media content collection to select the media assets, determining which individual media assets to include, determining how many media assets to include and/or determining how much to charge for the custom media bundle. As will be discussed in further detail below, any number of these determinations may be based on a user profile and/or environmental factors. The media bundle may have been generated simultaneously with the rest of user interface 500, or it may have been generated ahead of time for inclusion in subsequent advertisements and/or user interfaces.

An environmental factor is information regarding the current circumstances in which the custom media bundle is generated. This may include user interactions that have led to the display of a currently displayed user interface, such as the receipt of user input in text box 504, information contained within the currently displayed user interface, such as search results 506, the context of the current user interface, such as the fact that user interface 500 is a search engine for television series, a current time and/or date, and even the current position of an input visualization, such as a mouse pointer or focus frame. In the case of advertisement 608, for example, the custom media bundle was generated to be related to the search query inputted by the user into text box 504.

Furthermore, the large quantity of media assets included in the custom media bundle may be due to the fact that the custom media bundle was generated in response to expressive user input. For example, prior to the user searching for “comedy” another advertisement for a custom media bundle featuring only three episodes may have been displayed. This is because by receiving user input for searching for the term “comedy”, the media guidance application was able to select a media content collection that is very likely to appeal to the user. If a media content collection is likely to appeal to the user, the user is presumably also more likely to invest larger amounts of time and money in order to obtain a custom media bundle containing media assets of the media content collection. Conversely, if the media guidance application does not have a lot of information on the user's interests, there is a lower likelihood that a generated custom media bundle will appeal to the user, and thus it is safer for the media guidance application to advertise a smaller custom media bundle.

The custom media bundle promoted in advertisement 508 may also have been generated based on a user's media budget. The media budget may be originally inputted by the user (or another individual associated with the user) and may be stored in a user profile in storage 308 or storage of media guidance data source 418. The media budget may reflect the funds the user has available for purchasing media content. When the user purchases media content or other products, the media guidance application may automatically update the stored media budget by subtracting the cost of the purchased media content from the media budget.

In order to generate the custom media bundle advertised in advertisement 508, the media guidance application may have retrieved the media budget stored in the user profile, and determined how many media assets the user can afford to purchase. The media guidance application may then use this information to determine how many media assets to include in the custom media bundle, by, for example, limiting the number of media assets that can be included to the number of media assets the user can actually afford to purchase. In the case of advertisement 508, the media guidance application may have initially determined, based on the user's strong interest in comedies and the user's preference for purchasing entire seasons of television series, that the custom media bundle is to include 14 episodes of SOUTH PARK. However, the user's media budget may have only $7.00 remaining. Based on this information, and a cost per episode of $0.99, the media guidance application may have limited the maximum number of episodes that can be included in any custom media bundle to seven episodes, which in turn led the media guidance application to generate a custom media bundle that contains seven episodes of SOUTH PARK and that costs $6.93, as illustrated by advertisement 508.

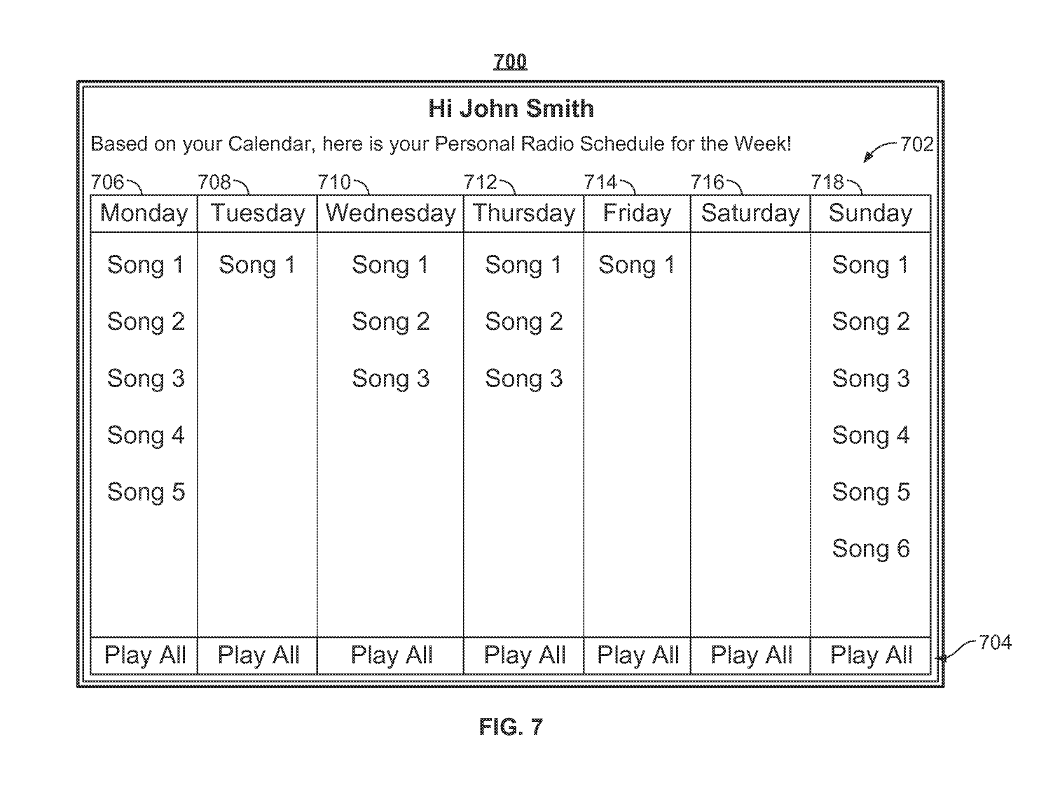

FIG. 6 demonstrates exemplary user interface 600 that has been generated by the media guidance application. User interface 600 may have been generated by the media guidance application running on user equipment device 300 and may provide media library feature 614 and media purchasing feature 602. User interface 600 may also include information region 604 for providing information on a media content collection. In response to receiving a user selection of option 606, the media guidance application may perform a financial transaction for granting the user access to the corresponding individual media asset of the media content collection. User interface 600 may further include pop-up window 608 for providing information regarding a custom media bundle. In response to receiving a user selection of option 610, the media guidance application may perform one or more financial transactions to grant the user access to the custom media bundle. In response to receiving a user selection 612, the media guidance application may proceed with the financial transaction for granting the user access to the originally selected individual media asset.

The custom media bundle introduced in pop-up window 608, similar to the custom media bundle advertised in advertisement 508, may also have been generated by the media guidance application based on environmental factors, specifically a user input indicating a strong user interest in purchasing media assets of the media content collection. However, the custom media bundle of pop-up window 608 further takes into account a user's viewing habits. Viewing habits, also referred to as viewing patterns, indicate the pattern in which a user watches, purchases and/or otherwise consumes media assets. For examples, some users will watch only one media asset at a time, while others prefer to sit down and watch multiple in a row. As another example, some users prefer to watch the episodes of a television series as they air, while others prefer to buy the entire season of the television series after all the episodes of that season have been released for streaming online. The media guidance application may track user interactions to determine the user's viewing pattern and store this information in the user profile. The media guidance application may then utilize this information when generating custom media bundles.

In the case user interface 600, the media guidance application may have monitored user viewing and/or purchasing activities, and determined that the user usually watches and/or purchases three episodes of a television series at a time. The media guidance application may also make more specific determinations. For example, the media guidance application may have determined that the user usually watches and/or purchases three episodes of a television series at a time if the television series belongs to a certain genre, if this is the first time the user is watching and/or purchasing episodes of this particular television series, if it is currently a particular time period such as the weekend or a weekday evening, and/or if the user has previously shown interest in media content related to the television series. When generating the custom media bundle advertised in pop-up window 608, the media guidance application may have determined, based on these monitored user viewing and/or purchasing activities, that the custom media bundle is going to include three episodes of SOUTH PARK, and generated the custom media bundle accordingly.

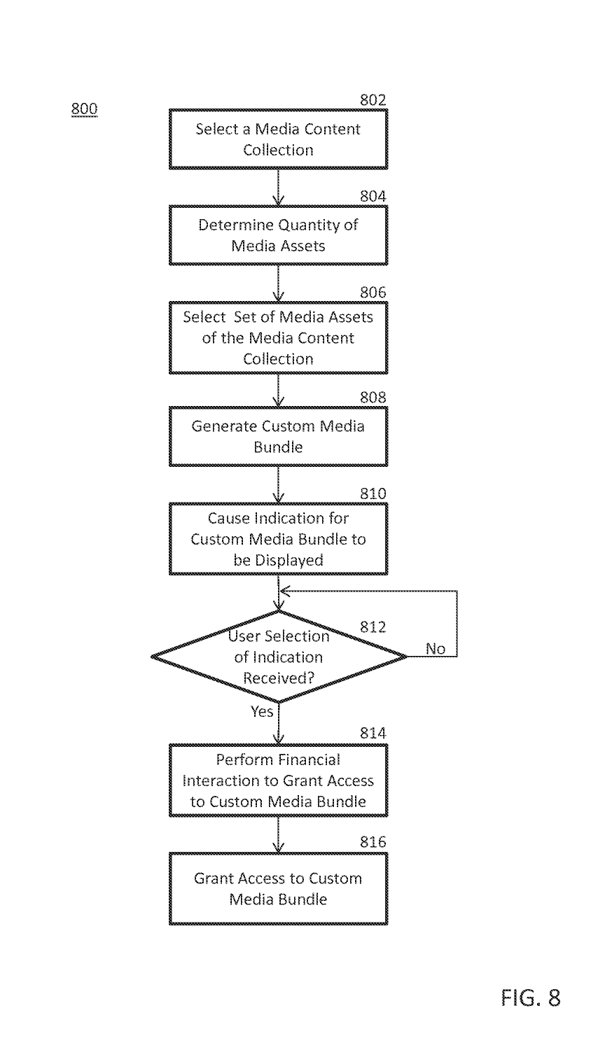

FIG. 7 demonstrates exemplary user interface 700 that has been generated by the media guidance application. User interface 700 includes custom media calendar 702 that consists of custom playlists that have been generated for each of days 706-718. User interface 700 also includes option 704 for playing the custom playlist generated for each day. In this context, each of these custom playlists may be a separate custom media bundle that has been generated by the media guidance application based on the user profile.

As demonstrated by user interface 700, the processes discussed in further detail below are not limited to television media and advertisements, but are equally applicable to other circumstances. In this case, user interface 700 may have been generated by the media guidance application to provide a custom music playlist for each day of the week.

As further demonstrated by interface 700, custom media bundles (e.g., the custom music playlists displayed for each day of the week in custom media calendar 702) may also be generated based on user input. In this case, custom music playlists 706-718 may have been generated based on a calendar inputted by the user. In one example, the user may enter an amount of time available for consuming media for each day of the week.

In another example, the user may input a calendar of obligations (either directly to the media guidance application or to another, potentially general purpose, calendar utilized by the user), and the media guidance application may use this calendar to calculate an amount of time the user has available for consuming media each day of the week. The particular calendar utilized for the generation of custom media calendar 702 may reflect the amount of time the user has available each day of the week for listening to music due to the user's commute to and from work. For example, the user may have to drive to an out of town meeting on Sunday and return home on Monday and thus have a long commute on each of those days. Accordingly, the user may enter the approximate duration of the commute for each of those two days into another user interface provided by the media guidance application in order to populate a calendar of time the user has available each day for listening to music.

The media guidance application may then utilize this information regarding how much time the user has available each day for listening to music to determine how long of a custom music playlist to generate for each day of the week. The determined length of each custom music playlist, also referred to as the quantity of media assets to be included in each custom media bundle, may be either a number of songs to include or a total song duration. In the first case, the media guidance application may assume that each song has an average duration, and calculate how many songs to add to each custom music playlist by dividing the user's available time for any given day by the average song duration. For example, the user may have a long commute on Mondays, and thus desire to listen to music for an extended period of time each Monday. This is reflected in custom media calendar 702 by the large number of songs assigned to day 706. The media guidance application may also take into account characteristics of each individual media asset when determining how many media assets to incorporate into the custom media bundle. This may involve selecting songs whose duration adds up to the time the user has available for listening to music. For example, the user may desire to listen to music for the same duration of time each day Tuesday through Friday. The media guidance application may take into account the duration of each song when generating the custom media bundle for each day of the week. The songs listed for days 708 and 714 may be thrice as long as the songs listed for days 710 and 712, thus resulting in a custom music playlist of equal length in time being assigned to each of those days.

The media guidance application may execute process 800 of FIG. 8 to generate a custom media bundle and displays a user selectable indication associated with the custom media bundle. In response to receiving a user selection of the indication, process 800 performs one or more financial transactions and grants the user access to the generated custom media bundle.

While the steps of process 800 will be discussed as being performed by the media guidance application, it is understood that this is for the sake of simplicity, and that any one of the steps may be performed by one or more of control circuitry 304 of user equipment device 300, control circuitry of media guidance data source 418 and/or control circuitry of media content source 416. Furthermore, process 800 may be executed by a combination of any of control circuitry 304 of user equipment device 300, control circuitry of media guidance data source 418 or control circuitry of media content source 416, and any step of process 800 may be performed by any one or more of these control circuitries. For example, media guidance data source 418 and/or media content source 416 may perform steps 802-812, user equipment device 300 may perform steps 814-816, and user equipment device 300, media guidance data source 418 or media content source 416 may perform steps 818-820.

The media guidance application first selects a media content collection at step 802. This may involve receiving a data structure identifying a media content collection from media content source 416 or another server associated with the content provider. For example, a content provider may determine that they want to advertise a new television series, and transmit information identifying the new television series and its episodes from media content source 416 or another server associated with the content provider to media guidance application data source 418 or user equipment device 300 for use by the media guidance application. Alternatively, such information may be given using any other form of communication.

The media guidance application may also select a media content collection based on direct user input. For example, the user may desire to get an idea of what a new television series is like. In response to receiving a user request for a custom media bundle based on this television series, the media guidance application may generate a custom media bundle containing a number of episodes of the television series.

The media guidance application may select a media content collection based on environmental factors. The media content collection may be selected based on a currently displayed user interface, a recently received user input, the purpose for which the custom media bundle is being generated and/or other contextual information. For example, if it is early morning on a Saturday, the user is more likely to be a child, and the media guidance application may thus select a cartoon series as the media content collection. As another example, if an advertisement for the custom media bundle is to be displayed within a list of upcoming comedies, the media guidance application may select a comedic series as the media content collection. As a third example, if the generation of the custom media bundle is triggered by receipt of user input requesting further information about an action movie, the media guidance application may select an action series as the media content collection.

The media guidance application may also select a media content collection based on a user profile. For example, if the media guidance application has determined that the user often watches sporting events, the media guidance application may select a series of live broadcasts of events of a sports tournament as the media content collection. As another example, the media guidance application may have previously received user input listing the user's favorite actors, and stored this information to the user profile. At a later time, the media guidance application may then select a media content collection starring a number of the user's favorite actors for use in the generation of a custom media bundle.

Selecting the media content collection may involve performing a search or otherwise retrieving information from a local database or a database of a remote server. This remote server may be associated with the content provider, such as media content source 416, may be associated with the provider of the media guidance application, such as media guidance data source 418, or may be a third party server. Selecting the media content collection may thus involve generating a search query in order to search for a media content collection based on any of the factors discussed above and receiving a data structure identifying the media content collection in response. Furthermore, the retrieving and/or searching may also be performed after a media content collection has been selected in order for the media guidance application to obtain more information associated with the media content collection.

The media guidance application may select the media content collection based on a combination of the factors discussed above. For example, the media guidance application may receive information identifying a number of potential media content collections from a content provider, and select the media content collection from the potential media content collections based on a user profile. As another example, the media guidance application may simultaneously or separately take both a user profile and environmental factors into account when selecting the media content collection.

The media guidance application may also skip step 802 initially, and use media assets that may or may not otherwise be related when generating the custom media bundle. In that case, the very generation of the custom media bundle consisting of these media assets also results in the creation of a media content collection consisting of these media assets.

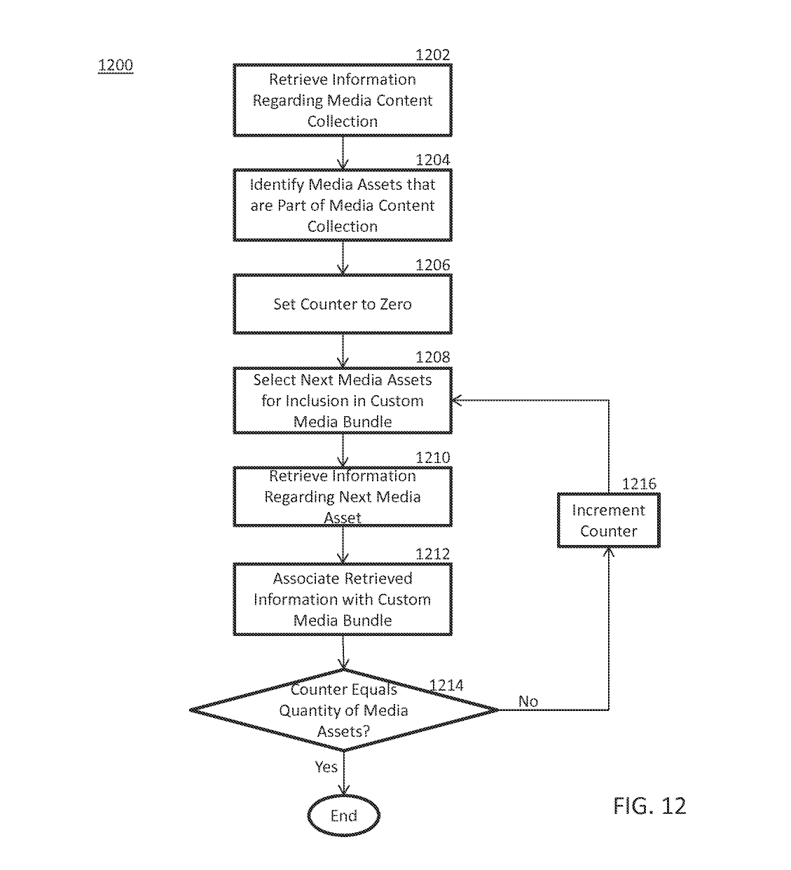

The media guidance application then determines a quantity of media assets to include in the custom media bundle at step 804. The quantity of media assets defines the number of media assets to include in the custom media bundle. The quantity may be an integer value defining the number of media assets to include or may be a calculated or retrieved number that sets criteria to be met by the custom media bundle as a whole. For example, the quantity of media assets may specify that the custom media bundle is to include five episodes of a television series. Alternatively or in combination, the quantity of media assets may specify that the custom media bundle is to have a total run-time of two hours or cost a total of $4.00 to obtain. The quantity of media assets may be specified by the content provider, may be specified by the provider of the media guidance application, may be manually selected by the user, may be determined based on environmental factors and/or may be determined based on a user profile. Further details regarding how step 804 may be performed are discussed in greater detail below in relations to FIGS. 10 and 11.

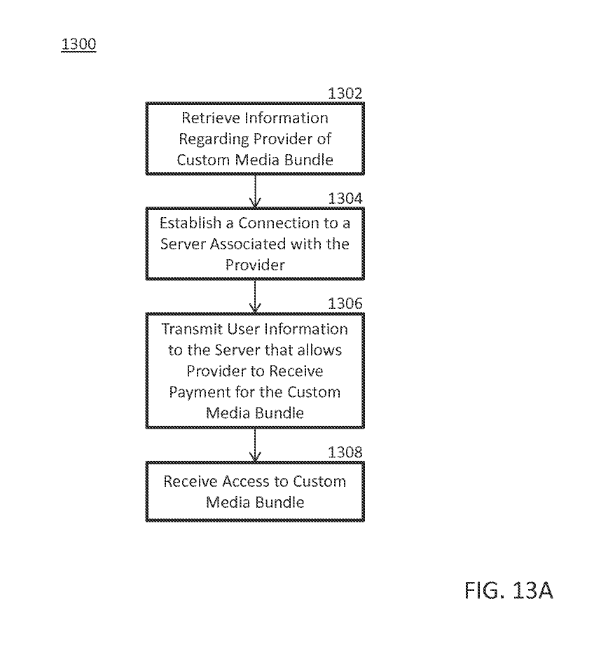

The media guidance application then selects a set of media assets to include in the custom media bundle at step 806. The selection of the media assets may also be based on the user profile and/or environmental factors, and will be discussed in further detail below in connection with FIG. 12.

The media guidance application then generates the custom media bundle at step 806. Generating the custom media bundle may involve storing information regarding the media content collection and/or the media assets selected at step 806 to a data structure of the custom media bundle. The step may further entail determining a price to charge for the custom media bundle. The price may be set by the content provider or a provider of the media guidance application, or may be calculated by the media guidance application. The price may take into consideration the determined quantity of media assets and the price of the individual media assets. The price of the individual media assets may be the price of the specifically selected media assets, may be a price for media assets of the selected media content collection, or may be a general price for any media assets of the selected type. For example, the media guidance application may utilize the same general price for any media asset of any media content collection, and may multiply this price by the number of media assets in the custom media bundle to calculate the price of the custom media bundle.

The price of the custom media bundle may be the same price as the price of the individual media assets combined, or it may further reflect an additional discount. This discount may be applied after an initial price is calculated, and may be proportional to the initial price (e.g., purchasing the custom media bundle costs 10% less than purchasing the media assets of the custom media bundle individually) or may be an absolute number (e.g., purchasing the custom media bundle costs $1.00 less than purchasing the media assets of the custom media bundle individually). Alternatively, or in combination, the discount may be applied as the price is being calculated in the first place. For example, the media guidance application may use a first price when advertising media assets individually, but use a second, lower, price when calculating the price of the custom media bundle.

The price of the custom media bundle may be further increased or decreased based on the user profile and/or environmental factors. For example, if the custom media bundle is generated based on received user input specifying the media content collection and requesting such a custom media bundle, the user is presumably more likely to buy the custom media bundle than if the custom media bundle is advertised on an unrelated website. Since the user in the first scenario is more likely to buy the custom media bundle regardless of price than the user in the second scenario, the custom media bundle in the first scenario may be priced higher than the custom media bundle in the second scenario. As another example, as will be further discussed below in relation to FIG. 9, the user profile may contain a user's media budget, the size of which may indicate the user's willingness to spend money, and the user's media budget may thus be taken into account when determining the price of the custom media bundle. As a third example, the media guidance application may store information regarding a user's previous purchases of media assets and/or media bundles to the user profile, and use this information when pricing the custom media bundle. In general, all techniques discussed below in relation to determining a user's level of interest in a media content collection in connection with FIGS. 10-11B can also be used to influence the price of the custom media bundle.

The media guidance application may then cause an indication for the custom media bundle to be displayed at step 810. This may include triggering the display of a pop-up, including the indication in a website or other user interface, or displaying a user interface specifically for the custom media bundle. The indication may include information identifying the media content collection and/or information identifying the individual media assets of the custom media bundle. The indication may further include information regarding why the custom media bundle has been generated (e.g., “This media bundle has be been generated based on your previous viewing pattern”). The indication may also include information regarding the one or more content providers from which the media assets of the custom media bundle can be obtained and/or the price of the custom media bundle that may or may not reflect any potential discount. The indication or an option contained within it may be user selectable, and, in response to receiving a user selection, the media guidance application may provide further information regarding the custom media bundle, provide access the media assets of the custom media bundle, and/or perform the necessary financial transactions for granting the user access to the custom media bundle.

The media guidance application may determine at step 812 whether a user selection of the indication has been received. As long as a user selection has not been received and the user has not otherwise navigated away from the user interface that includes the indication, the media guidance application may continue to display the indication. If at step 812 a user selection of the indication is received, the media guidance application may proceed to step 814.

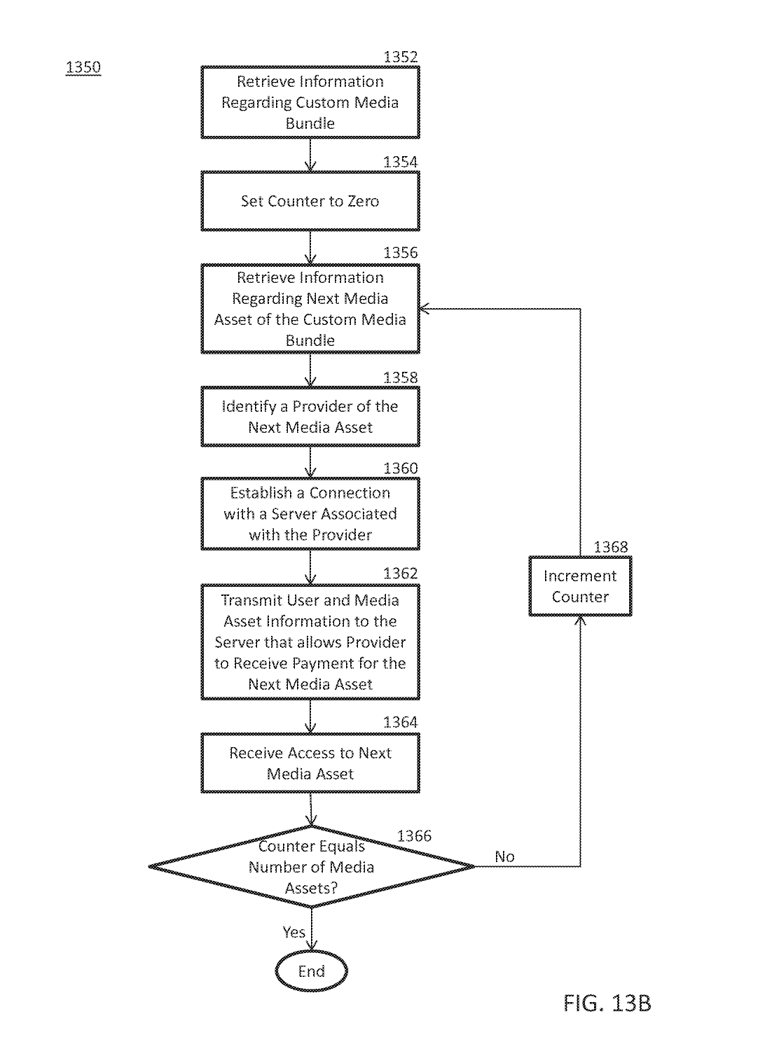

In response to receiving a user selection of the indication, the media guidance application may perform one or more financial transactions at step 814 in order to grant the user access to the media assets of the custom media bundle. These financial transactions may be between the user and the provider of the media guidance application, between the provider of the media guidance application and the content provider and/or between the user and the content provider. These financial transactions result in the user being charged for the media assets of the custom media bundle, and may be based on information stored to the data structure of the custom media bundle. Further details regarding how these financial transactions are performed are discussed below in connection with FIGS. 13A and 13B.

While the majority of the discussion focuses on media assets that cost the user money to access, this need not always be the case. The custom media bundle may also be free of charge for the user to access, rendering this step 814 unnecessary.

Finally, at step 816, the media guidance application may grant the user access to the media assets of the custom media bundle. How access is granted may depend on the type of access provided by the content provider. For example, media content source 416 may transmit the media assets as digital data for either immediate viewing (i.e., streaming) or saving to a memory of user equipment device 300 (i.e., downloading). The content provider may also ship physical merchandise embodying the custom media bundle to a location associated with the user. Granting access to the custom media bundle may also be based on information stored to the data structure of the custom media bundle. Furthermore, the device on which the access is granted may be the same or a different device than user equipment device 300 and/or the device that executed process 800.

FIG. 9 shows exemplary user profile 900 consisting of entered information 902, media budget 904, budget periodicity 906, time availability 908, content preference 910, retrieved information 912, user characteristics 914, time availability 916, monitored user interactions 918, history of user interaction 920, viewing pattern 922 and content preferences 924. User profile 900 may consist of a single or multiple data structures, and may be stored in storage 308 of user equipment device 300, a memory of media guidance source 418, a memory of media content source 416, a memory of a third party server, or a combination thereof. Furthermore, a user profile may contain all information discussed in connection with user profile 900, or only a subset thereof. Finally, any information listed under entered information 902, retrieved information 912 or monitored user interactions 920 may also be acquired using either of the other two approaches. For example, user interactions with the media guidance application may be monitored to estimate demographic characteristics of the user, and the user's media budget may be retrieved from another feature of the media guidance application or another application.

Entered information 902 consists of information entered by the user for use by the media guidance application. This information may include media budget 904 that has been entered by the user. The media budget is a budget set by the user for spending on media assets. For example, the user may have an account saved by the media guidance application that is specifically used for purchasing media assets. When the user purchases a media asset, the media asset is billed to the user's media budget instead of an actual bank account or credit card. Alternatively, the media budget may be solely for informative purposes. The media guidance application may use the media budget to help the user keep track of his or her spending, to warn the user if the media budget is getting low or goes negative and/or to generally limit the user's spending on media content, while purchasing media assets may still involve charging an actual bank account or credit card of the user.

When generating a custom media bundle, the media guidance application may determine the quantity of media assets based on the media budget. This may involve ensuring that the user's media budget has enough funds to allow the user to purchase access to all the media assets of the custom media bundle. For example, if the media budget has $5 remaining, and each media asset costs $1, the media guidance application may determine the quantity of media assets to be five media assets. Alternatively, the quantity of media items may be defined as $5.

The media budget may be replenished periodically. For example, the user may add $20 every month to the media budget, or reset the media budget to $20 at the beginning of every month. If that is the case, the user profile may contain budget periodicity 906 for storing the period with and/or date on which the media budget will be increased. So, in the above example, the media guidance may store information to the user profile indicating that the media budget will be increased by $20 on the first of every month.

This information, in combination with a current time within this period, may also be used to determine the quantity of media assets. For example, the media guidance application may calculate what percentage of the monthly budget is remaining (e.g., what percent of $20 is remaining) and compare this to the percentage of the period that is remaining (e.g., what percent of the month has already passed). The media guidance application may then compare these two percentages to determine if the user's spending is ahead or behind schedule, and use this information when determining the quantity of media assets to include in the custom media bundle. Thus, if the user has used up 75% of the budget, but only 25% of the month has passed, the media guidance application may recommend a smaller and/or cheaper custom media bundle than if the user has used up 25% of the budget, but a full 75% of the month has already passed. A similar result may also be achieved by having the media guidance application calculate how much a user ought to spend in smaller time increments in order to use up the entire media budget prior to the periodic increase or by calculating a schedule of how much budget the user ought to have remaining at these smaller increments and use this information to determine whether the user's spending is ahead or behind schedule, and to adjust the determined quantity of media assets accordingly.

User profile 900 may also contain time availability 908. This is an indication of how much time a user has available. The value may be entered ahead of time by the user, and the user may specify different time availabilities for different time periods. For example, the user may specify how many minutes, if any, the user has available for each day of the week. The media guidance application may then generate a custom media bundle with a total run-time less than or equal to the user's available time. This may further entail determining what the current time period is in order to retrieve the corresponding time availability. For example, the media guidance application may determine that it is currently Wednesday and look up that on Wednesdays the user has one hour available for watching media assets. Based on this information, the media guidance application may generate a custom media bundle consisting of two episodes of a television series. This may involve comparing the available time against a general run time of media assets of any media content collection, against the run time of media assets of the selected media content collection, or against the run time of the actual media assets to be included in the custom media bundle.

User profile 910 may also include content preferences 910. Content preferences 910 include information regarding media content the user does or likely will enjoy. This may entail things favorited by the user, such as a user's favorite genre, actor, media content collection, etc. This information may then be used by the media guidance application to determine how interested a user will likely be in a media content collection. If a user is very likely to be interested in a media content collection, the user is also likely to be interested in a media bundle consisting of media assets of the media content collection, and willing to purchase more of these media assets as part of a custom media bundle. Therefore, content preferences 910 may be used to estimate how interested a user might be in a media content collection, which in turn would be factored in when determining the quantity of media assets to include in the custom media bundle. For example, if content preferences 910 indicate that the user loves comedies and cartoons, and media content source 416 indicates that a custom media bundle consisting of episodes of SOUTH PARK is to be advertised, the user is likely to enjoy the media content collection, and a custom media bundle with eight episodes of SOUTH PARK is generated since the user will likely be willing to purchase such a large custom media bundle. However, given the same user profile, if media content source 416 indicates that a custom media bundle consisting of episodes of AMERICAN HORROR STORY is to be advertised, only a single episode of AMERICAN HORROR STORY may be included in the custom media bundle, since content preference 910 would not match traits of AMERICAN HORROR STORY, and the user would thus be less likely to want to dedicate a lot of time and/or money to a large custom media bundle.

User profile 900 may also include retrieved information 912. This is information entered by the user or otherwise assembled in connection with other features of the media guidance application or other application altogether. For example, retrieved information 912 may include billing information the user entered when initially setting up the media guidance application, or may include information that has been determined based on monitoring performed by an altogether different application. As another example, retrieved information 912 may be a user's profile on a social networking website or any other account. This information may be collected and stored in the same data structure as the rest of user profile 900 or may be retrieved on the fly when needed from another data structure. Retrieved information 912 may have originally been stored in the same memory as the rest of user profile 900, or it may need to be retrieved from a remote server.

Retrieved information 912 may include user characteristics 914. These may include demographic or employment information for the user. Alternatively, retrieved information 912 may also have been part of entered information 902. User characteristics 912 may be used by the media guidance application either to look up further information on the user, or it may directly be associated with potential features of a custom media bundle. User characteristics 912 may thus be used, for example, to determine what type of content the user is likely to be interested in, which in turn may impact the determined quantity of media assets in a similar manner as content preference 910 discussed above. In this example, different media content collections may have different demographic groups associated with them, or each media content collection may have an enjoyment probability value for each such demographic group.

Similarly, user characteristics 914 may be used to determine how much time the user is likely to have available for each day of the week, which in turn is used to determine the quantity of media assets. For example, the media application may have access to a data structure associating each of a number of different demographic groups with different sample availability, such as a data structure that indicates that adults ages 22-26 have one hour of available time Monday through Friday, and 3 hours of available time Saturday and Sunday. The media guidance application may use such data structures to select a sample availability based on a user's demographic characteristics, and in turn use the selected sample availability to determine a quantity of media assets.

Alternatively, user characteristics may be directly associated with quantities of media assets that are to be included in any custom media bundle for any user having specific user characteristics. Thus, custom media bundles generated for adults ages 18-22 may always have eight media assets, while custom media bundles generated for adults ages 22-26 may always have two media assets.

User profile 900 may also include time availability 916. This information may be used in a similar manner as time availability 908. However, time availability 916 may be generated by accessing a user's personal calendar, and thus directly determining how much time a user has available on any particular day. So, for example, if the user's calendar has a fully booked day on the day the custom media bundle is generated, the custom media bundle may contain only a single media asset, while if the day is completely empty the custom media bundle may contain four media assets. Furthermore, if the next item on the calendar is three hours from a current moment in time, the media guidance application may determine that at that instant the user has the next three hours available, and generate a custom media bundle accordingly.

User profile 918 may also contain monitored user interactions 918. Monitored user interactions 918 consists of information ascertained by the media guidance application based on the monitoring of the user's previous interactions with the media guidance application.

Monitored user interactions 918 may include the history of user interactions 920. History of user interactions 920 may include information on media assets previously played by the user or that the user has otherwise interacted with. This may include media assets previously purchased by the user. If a user has previously watched multiple media assets of a media content collection, it is highly likely that the user has enjoyed the media content collection, and that he or she would thus likely be willing to invest further time and/or money in a large custom media bundle consisting of further media assets of the media content collection. Alternatively, or in combination, if a user has only watched one or two media assets of a media content collection, especially if this occurred a long time ago, it is highly likely that the user did not enjoy the experience, and that he or she would thus not be interested in purchasing a large custom media bundle consisting of further media assets of the media content collection. History of user interactions 920 may further be used to avoid incorporating media assets of a media content collection into a custom media bundle that the user has already watched, as he or she will presumably not want to purchase a copy of already seen media assets.

Monitored user interactions 920 may also include viewing pattern 922. Viewing pattern 922 contains information on a user's viewing habits in relation to media content collections. Some users generally enjoy watching only a few media assets of a media content collection at a time, while others prefer to sit down and watch a large number of media assets or a certain grouping of media assets. For example, a first user may be prone to watching an entire season of a television series at a time, while a second user may watch two to three episodes of a television series before loosing interest and looking for another television series. The media guidance application may monitor user interactions to determine a user's preferred viewing pattern, and determine the quantity of media assets to include in the custom media bundle based on this information. Referring back to the two exemplary users above, for the first user the media guidance application may generate a custom media bundle consisting of every episode of a season of a television series, while for user two the media guidance application may generate a custom media bundle consisting of three episodes.

The media guidance application may also determine viewing patterns for a number of time periods, and use the viewing pattern associated with a current time period when determining the quantity of media assets to include in the custom media bundle. The media guidance application may determine this information by monitoring user interactions with the media guidance application at each of the time periods, and average these interactions over time as these time periods are repeated. The media guidance application may thus, for example, determine a viewing pattern for the user for each day of the week. In this example, the media guidance application may determine that the user watches three hours worth of media assets every Saturday. If a custom media bundle is to be generated on a Saturday, the media guidance application may then determine the quantity of media assets to include in the custom media bundle based on the fact that the user is likely to want to watch media assets for three hours.

Finally, the media guidance application may also monitor user interactions to determine content preferences 924. Content preferences 924 may contain similar information and be used in a similar manner as content preferences 910.

Process 1000 of FIG. 10 shows in greater detail step 804 of process 800. First, the media guidance application may retrieve the user profile at step 1002. This may involve retrieving one or more data structures associated with either all of user profile 900 or only a part thereof. If the entire user profile is retrieved, particular fields of the user profile may be identified to retrieve relevant user information at step 1004. Alternatively, only a data structure corresponding to the relevant user information may be retrieved from memory.

Then, at step 1006, the media guidance application may retrieve relevant media asset characteristics. These characteristics may indicate what the run-time of a media asset is or how much accessing the media asset would cost. This information may be retrieved directly from a data structure associated with a particular media asset, from a data structure associated with the selected media content collection, or this information may be stored in memory as general traits of any media asset. The media guidance application may also retrieve media asset characteristics that are not directly relevant to determining the quantity of media assets, and use this information to look up the relevant media asset characteristics. For example, the media guidance application may retrieve information identifying what type of media content the media assets are from a data structure associated with the media content collection (e.g., episodes of a television series, movies, songs, etc.), and use this information to look up relevant characteristics for that type of media content (e.g., episodes of a television series are generally half an hour long, movies usually cost $4.99, and song generally cost $0.99, etc.). As another example, the media guidance application may retrieve information identifying a content provider of the media asset from a data structure associated with the media content collection, and then use this information to retrieve relevant media asset characteristics.

The relevant media asset characteristics and/or media asset characteristics that are not directly relevant to determining the quantity of media assets may be retrieved from local memory, media guidance data source 418, media content source 416 or a third-party server. The characteristics may also be automatically received from media content source 416 along with a selection of a media content collection (as discussed above in connection with step 802 of process 800) or searched for by the media guidance application.

Once the relevant user information and the relevant media asset characteristics have been retrieved, the quantity of media assets to include in the custom media bundle may be calculated by the media guidance application based on that information at step 1008. Calculating may involve performing actual arithmetic computations, looking up a result from a look-up table, selecting one of a limited number of options, or any combination thereof. All factors involved in the calculation may be taken into account at the same time, or the quantity of media assets may be altered over a number of sequential stages, with each stage accounting for different factors.

The quantity of media assets may be initially set to a default value. This may be a default value set by the content provider or the provider of the media guidance application. Alternatively, the initially value may be calculated based on media budget 904 and/or time availabilities 908 and/or 916. This may involve dividing media budget 904 and/or time availability 908 by the cost of the individual media asset and its run-length respectively. Alternatively, media assets can be added to the custom media bundle and a running total incremented until media budget 904 and/or time availability 908 has been met. If media budget 904 is incremented periodically, this periodicity may also be taken into account. For example, the media guidance application could determine how much money a user can spend without running into the risk of depleting his or her budget before it is incremented again, and this value may be used to determine the quantity of media assets.

These calculations may also involve using a look-up table or otherwise selecting from a limited set of potential choices. For example, the media guidance application may have access to a table that lists quantities of media assets, or even pre-generated custom media bundles, for a number of different media budgets, time availabilities, viewing patterns and/or any other information found within user profile 900, and the media guidance application may select from these based on any of the relevant user information. This look-up table may be received along with the selection of the media content collection from media content source 416, may be stored locally, or may be stored at media guidance data source 418. For example, the data structure for the media content collection that is received from media content source 416 may contain different sets of media assets containing different quantities of media assets for different potential media budgets, and the media guidance application may select the appropriate set based on media budget 904.

Alternatively, calculating the quantity of media assets may not involve any relevant media asset characteristics, thereby eliminating the need for step 1006. For example, the quantity of media assets may be set to a number of media assets retrieved from viewing pattern 922.

The quantity of media assets to include in the custom media bundle may be further increased or decreased based on user profile 900. For example, if content preferences 910 matches characteristics of the media assets or the media content collection, the user is more likely to want to purchase a larger custom media bundle, and the quantity of media assets may thus be accordingly increased. Similarly, if history of user interactions 920 indicates that the user has never seen any media assets of the media content collections, the quantity of media assets may be decreased, since a user is unlikely to want to invest a lot of money and/or time in a custom media bundle of media assets of a media content collection that he or she is not familiar with.

The media guidance application may also set limits based on information found in user profile 900. For example, the media guidance application may set a maximum quantity of media assets that may be included in a custom media bundle if the user has never seen any media assets of the selected media content collection. However, if the history of user interactions 920 indicates that the user has previously seen some of these media assets, the limit may no longer apply.

The media guidance application may further consider environmental factors when determining the quantity of media assets to include in the custom media bundle using process 1100 of FIG. 11A. As with step 1002 of FIG. 10, the media guidance application may initially retrieve the user profile or the relevant user information found therein.

The media guidance application may then determine one or more environmental factors at step 1104. This may involve reading a current time stamp, determining what day of the week it is, determining what user interface is currently displayed, looking up recent user inputs and/or figuring out what the user's current level of interaction with the media guidance application is.

Step 1106 is similar to step 1008 of process 1000, except that in step 1106, besides taking into account relevant user information and potentially relevant media asset characteristics, the media guidance application further takes into account the one or more environmental factors when determining the quantity of media assets. This may involve having another dimension in a look up table, using a different look-up table depending on what environmental factors apply, and/or including a further term in any computational calculations. For example, the media guidance application may use a first look-up table if the custom media bundle is generated for inclusion in an advertisement, and a second look-up table if the custom media bundle is generated in response to receiving a user request for a specific media content collection. As another example, as previously discussed, the applicable viewing pattern may be selected based on a current time period. As a third example, if the user has expressively requested a custom media bundle, the calculated quantity of media items may be automatically multiplied by a factor of two.

Process 1150 of FIG. 11B is an alternative process for incorporating environmental factors when calculating the quantity of media assets to include in a custom media bundle. Steps 1152 and 1154 of process 1150 correspond to process 1000. After an initial quantity of media assets has been determined at step 1154, the media guidance application may then determine similar environmental factors as those discussed above in connection with step 1104 of process 1100.

At step 1158, the media guidance application may determine if the environmental factors justify adjustment of the initial quantity of media assets and are thus relevant. If they are relevant, the quantity of media assets is adjusted at step 1160. Otherwise, the initial quantity of media assets is used for generating the custom media bundle. For example, if the user has been very actively interacting with the media guidance application, the quantity of media assets may be increased. As another example, if the media content collection to be advertised is not at all related to a currently displayed user interface, the quantity of media assets may be decreased.

While processes 1100 and 1150 discussed environmental factors only as being used in combination with the user profile for generating the custom media bundle, this need not be the case. A custom media bundle may also be generated solely based on environmental factors without taking into account the user profile. For example, the quantity of media assets to be included in the custom media bundle may be entirely determined based on how closely related the media content collection is to the currently displayed user interface. As another example, the quantity of media items may be determined solely based on a current time of day and/or day of the week. Larger custom media bundles may be generated and advertised on weekends than weekdays.

Once a quantity of media assets has been determined, a set of media assets is selected and the custom media bundle is generated by the media guidance application using process 1200. Process 1200 shows in greater detail the steps involved in performing steps 806 and 808 of process 800.

First, the media guidance application may retrieve a data structure associated with the media content collection. This may be the same or a different data structure as the one involved in initially selecting the media content collection. For example, the data structure may be received from media content source 416 as part of a request for the media guidance application to include an advertisement for the media content collection. As a second example, if the media guidance application selects the media content collection via a search, the data structure may be returned as a result of this search from either local memory, media guidance data source 418 or a third party server. A data structure associated with the media content collection may also be retrieved separately from the selection of the media content collection. For example, the media content collection may be selected using any of the methods discussed above, with the data structure then received in response to a request identifying the media content collection from any one of local memory, media content source 416, media guidance data source 418 or a third-party server.

Once information regarding the media content collection has been retrieved, media assets of the media content collection are identified at step 1204. The media assets may be identified based on the data structure retrieved in step 1202. For example, a data structure received from media content source 1416 may contain both information identifying the media content collection and information identifying each of the media assets that make up the media content collection. Alternatively, information on the individual media assets may be received from any one of local memory, media content source 416, media guidance data source 418 or a third party server in response to a search query requesting such information.

The media guidance application may also survey media assets offered by multiple different content providers from multiple servers as part of identifying media assets. For example, the identified media assets may include a first media asset from media content source 416 and a second media asset from a different second media content source. The media guidance application may thus locate the media assets available for purchase from one or more content providers, and repackage these media assets into a custom media bundle for sale to the user.

At step 1206 the media guidance application sets a counter to zero. Setting the counter may involve storing zero to a register or variable in the address space of the media guidance application.

Next, the media guidance application selects a media asset for inclusion in the custom media bundle at step 1208. This may involve simply taking the next media asset in a ranked list, selecting the media asset at random, selecting the most popular media asset based on ratings given by users and/or editors or according to real-time ratings and/or selecting a media asset that best matches content preferences 910 or 924. Process 1200 may further ensure that any selected media asset has not previously been watched and/or purchased by the user by comparing the media asset against the history of user interactions 918. The ranked list may be received together with the selected media content collection from media content source 416, and illustrate the order of preference of the media assets to the content provider. Media content source 416 may thus encourage the media guidance application to predominantly include media assets in custom media bundles that the content provider has to pay a lower royalty fee for as compared to media assets further down the ranked list.

The media guidance application then retrieves information regarding the selected media asset at step 1210. This information may be retrieved from a data structure associated with the media asset that is contained within the data structure retrieved for the media content collection at step 1202 or a data structure retrieved for the particular media asset as part of step 1204. Alternatively, instead of actually retrieving the information, the media guidance application may generate a pointer to the memory location where this information can be found.

At step 1212, the retrieved information, or a pointer thereto, is then added to a data structure associated with the custom media bundle, thereby adding the media asset to the custom media bundle. This data structure for the custom media bundle may be created each time a new custom media bundle is generated or a template may be used. Furthermore, the data structure for the custom media bundle may also include information found in the data structure of the media content collection or a pointer thereto.

The media guidance application at step 1214 may determine whether the counter is equal to the quantity of media assets previously calculated. The quantity of media assets may reflect the number of the media assets to be included in the custom media bundle, in which case step 1214 may be performed as part of a for-loop. Alternatively, the counter may keep track of the total cost and/or total run-time of the entire custom media bundle given the current number of media assets that has been added, in which case step 1214 may compare the counter to media budget 904, time availabilities 908 or 916 and/or viewing pattern 922. In that case, step 1214 may be implemented as a while-loop that keeps adding media assets to the custom media bundle until an exit condition associated with user profile 900 has been met.

If the media guidance application determines at step 1214 that further media assets are to be added, the counter is incremented. If the counter reflects a number of media assets to be added, the counter is simply incremented by one. However, if the counter reflects other characteristics of the custom media bundle, such as cost and/or run time, the counter is incremented by the cost and/or run time of the just added media asset. This information may be obtained for a specific media asset based on the data structure for that media asset retrieved at step 1204, for any media asset of the media content collection based on the data structure for the media content collection retrieved at step 1202, or for any media asset of any media content collection. Process 1200 then returns to step 1208 and selects the next media asset for inclusion in the custom media bundle. Steps 1208-1216 are repeated until the custom media bundle contains the determined quantity of media assets.

Process 1300 of FIG. 13A provides further details regarding step 814 of process 800. Process 1300 may be executed if the custom media bundle contains media assets available for sale as a single item from a single content provider, such as media content source 416. This process may also be executed if the content provider has requested an advertisement for the custom media bundle to be displayed and/or is otherwise involved in the generation of the custom media bundle. Process 1300 performs a single financial transaction in order to grant the user access to the custom media bundle.

At step 1302, the media guidance application may retrieve information identifying the content provider of the custom media bundle from the data structure for the custom media bundle. This information may consist of a link to media content source 416, an IP address associated with media content source 416, or other information identifying media content source 416. The media guidance application may then use this information at step 1304 to establish a connection with media content source 416. Depending upon where the media guidance application is executed, this may involve establishing a connection between user equipment device 300 and media content source 416 or between media guidance data source 418 and media content source 416.

Next, the media guidance application transmits user information to media content source 416 that allows the content provider to charge the user for the custom media bundle. This information may include the user's name, billing address, credit card number, bank or other account number, PAYPAL information and/or other information necessary to complete a financial transaction. The media guidance application may further transmit information to the media content source 416 identifying the individual media assets of the custom media bundle. These two pieces of information may also be transmitted to media content source 416 from separate devices. For example, media guidance data source 418 may transmit information to media content source 416 informing media content source 416 of a custom media bundle that has been generated and its content, and associate this custom media bundle with a particular ID number. In response to receiving a user selection of an indication associated with the custom media bundle, user equipment device 300 may then transmit the user information and the ID for the custom media bundle to media content source 416 in order to initiate the purchase of the custom media bundle.

Once the financial transaction is complete, media content source 416 may provide the user with access to the custom media bundle. This may involve transmitting the media assets as digital data for either immediate viewing (i.e., streaming) or saving to a memory of user equipment device 300 (i.e., downloading). The content provider may also ship physical merchandize embodying the custom media bundle to a location associated with the user.

Process 1350 of FIG. 13B provides further details regarding an alternative embodiment of step 814 of process 800. Process 1350 performs multiple financial transactions in order to grant the user access to the custom media bundle. Process 1300 and process 1350 may also both be performed. For example, in case the provider of the media guidance application is repackaging media assets available from one or more content providers for re-sale to the user, the media guidance application may first execute process 1300 to perform a single financial transaction between the user and the provider of the media guidance application, and then separately perform one or more financial transactions between the provider of the media guidance application and the one or more content providers. This implementation would allow the provider of the media guidance application to negotiate a better deal with content providers and/or re-sell media assets to users at a higher price via custom media bundles.

The media guidance application first retrieves the data structure of the custom media bundle at step 1352. Depending upon which control circuitry executes each of the steps of process 800, the data structure may be either retrieved from local memory or retrieved from media guidance data source 418. The media guidance application then sets a counter to zero at step 1354. Setting the counter may involve storing zero to a register or variable in the address space of the media guidance application.

Next, the media guidance application retrieves information regarding the first media asset of the custom media bundle at step 1356. This may involve retrieving information from the data structure of the custom media bundle or following pointers to separate data structures for the individual media assets of the custom media bundle. The retrieved information is then used to identify a content provider of the media asset, such as media content source 416.

Steps 1358-1364 are similar to steps 1302-1308 of process 1300, except, instead of performing a single financial transaction and granting access to the entire media bundle, steps 1358-1364 only perform a financial transaction and grant access to a single media asset of the custom media bundle.

At step 1366, the media guidance application determines if the user has received access to all media assets of the media content collection by determining whether the counter equals the number of media assets in the custom media bundle. If it does not, the counter is incremented by one at step 1368. If it does, all necessary financial transactions are complete and the user has been granted access to all media assets of the media content collection.

It will be apparent to those of ordinary skill in the art that the systems and methods involved in the present application may be embodied in a computer program product that includes a computer usable, non-transitory, and/or readable medium. For example, such a computer usable medium may consist of a read only memory device, such as a CD ROM disk or conventional ROM devices, or a random access memory, such as a hard drive device or a computer diskette, or flash memory device having a computer readable program code stored thereon.

It is understood that the various features, elements, or processes of the foregoing figures and description are interchangeable or combinable to realize or practice the implementations describe herein. Those skilled in the art will appreciate that aspects of the application can be practiced by other than the described implementations, which are presented for purposes of illustration rather than of limitation, and the aspects are limited only by the claims which follow.

1. A method for generating a custom media bundle for a user, the method comprising:
retrieving a first data structure, wherein the first data structure comprises a user profile;
determining, based on the user profile, a quantity of media assets to include in the custom media bundle;
selecting a media content collection that comprises a plurality of media assets;
retrieving a second data structure associated with the selected media content collection;
selecting, based on the user profile and the retrieved second data structure, a set of media assets from the plurality of media assets that includes a number of media assets corresponding to the determined quantity;
generating the custom media bundle that includes the selected set of media assets by populating a third data structure based on the second data structure; and
in response to receiving a user request to purchase the custom media bundle, performing one or more financial transactions based on the third data structure to grant the user access to the set of media assets of the custom media bundle.

2. The method of claim 1, wherein:
the media content collection is a media series; and
the plurality of media assets is a plurality of episodes of the media series.

3. The method of claim 1, wherein determining the quantity of media is further based on an environmental factor.

4. The method of claim 3, wherein the environmental factor comprises a context under which the custom media bundle is generated.

5. The method of claim 1, wherein:
the user profile comprises information regarding previous user interactions with the media content collection; and
determining the quantity of media assets comprises increasing the quantity based on the information.

6. The method of claim 1, wherein
the user profile comprises a user budget for purchasing media; and
determining the quantity of media assets comprises comparing the cost of one or more media assets to the user budget.

7. The method of claim 6, wherein:
the user budget is increased periodically; and
determining the quantity of media assets comprises:
calculating an available user budget based on time remaining until the user budget is increased and the user budget; and
comparing the cost of one or more media assets to the available user budget.

8. The method of claim 1, further comprising:
monitoring user activity to determine a viewing pattern for media assets;
storing the viewing pattern in the user profile; and
determining the quantity of media assets based on the stored viewing pattern.

9. The method of claim 8, further comprising:
monitoring user activity during a plurality of time periods to determine a plurality of viewing patterns associated with the plurality of time periods;
determining a current time period;
determining a current viewing pattern by matching the current time period with the plurality of time periods; and
determining the quantity of media assets based on the current viewing pattern.

10. The method of claim 1, further comprising:
storing demographic characteristics for the user in the user profile;
associating a plurality of sample viewing patterns with a plurality of sample demographic characteristics;
determining an actual viewing pattern by matching the stored demographic characteristics for the user with the plurality of sample demographic characteristics; and
determining the quantity of media assets based on the actual viewing pattern.

11. A system for generating a custom media bundle for a user, the system comprising:
control circuitry configured to:
retrieve a first data structure, wherein the first data structure comprises a user profile;
determine, based on the user profile, a quantity of media assets to include in the custom media bundle;
select a media content collection that comprises a plurality of media assets;
retrieve a second data structure associated with the selected media content collection;
select, based on the user profile and the retrieved second data structure, a set of media assets from the plurality of media assets that includes a number of media assets corresponding to the determined quantity;
generate the custom media bundle that includes the selected set of media assets by populating a third data structure based on the second data structure; and
in response to receiving a user request to purchase the custom media bundle, perform one or more financial transactions based on the third data structure to grant the user access to the set of media assets of the custom media bundle.

12. The system of claim 11, wherein:
the media content collection is a media series; and
the plurality of media assets is a plurality of episodes of the media series.

13. The system of claim 11, wherein the control circuitry is further configured to determine the quantity of media based on an environmental factor.

14. The system of claim 13, wherein the environmental factor comprises a context under which the custom media bundle is generated.

15. The system of claim 11, wherein:
the user profile comprises information regarding previous user interactions with the media content collection; and
the control circuitry is configured to determine the quantity of media assets by being further configured to increase the quantity based on the information.

16. The system of claim 11, wherein
the user profile comprises a user budget for purchasing media; and
the control circuitry is configured to determine the quantity of media assets by being further configured to compare the cost of one or more media assets to the user budget.

17. The system of claim 16, wherein:
the user budget is increased periodically; and
the control circuitry is configured to determine the quantity of media assets by being further configured to:
calculate an available user budget based on time remaining until the user budget is increased and the user budget; and
compare the cost of one or more media assets to the available user budget.

18. The system of claim 11, wherein the control circuitry is further configured to:
monitor user activity to determine a viewing pattern for media assets;
store the viewing pattern in the user profile; and
determine the quantity of media assets based on the stored viewing pattern.

19. The system of claim 18, wherein the control circuitry is further configured to:
monitor user activity during a plurality of time periods to determine a plurality of viewing patterns associated with the plurality of time periods;
determine a current time period;
determine a current viewing pattern by matching the current time period with the plurality of time periods; and
determine the quantity of media assets based on the current viewing pattern.

20. The system of claim 11, wherein the control circuitry is further configured to:
store demographic characteristics for the user in the user profile;
associate a plurality of sample viewing patterns with a plurality of sample demographic characteristics;
determine an actual viewing pattern by matching the stored demographic characteristics for the user with the plurality of sample demographic characteristics; and
determine the quantity of media assets based on the actual viewing pattern.

21-30. (canceled)
